(19) United States
(12) Patent Application Publication
(10) Pub. No.: US 2014/0362015 A1
(43) Pub. Date: Dec. 11, 2014

(54) METHOD AND DEVICE FOR CONTROLLING THE DISPLAYING OF INTERFACE CONTENT

(71) Applicant: TENCENT TECHNOLOGY (SHENZHEN) COMPANY LIMITED, Shenzhen City (CN)

(72) Inventor: Ruilin MA, Shenzhen City (CN)

(73) Assignee: TENCENT TECHNOLOGY (SHENZHEN) COMPANY LIMITED, Shenzhen City (CN)

(21) Appl. No.: 14/330,447

(22) Filed: Jul. 14, 2014

Related U.S. Application Data
(63) Continuation of application No. PCT/CN2013/089061, filed on Dec. 11, 2013.

(30) Foreign Application Priority Data
Jun. 7, 2013 (CN) 201310226298.3

(51) Int. Cl. G06F 21/60; G06F 3/0484

(52) U.S. Cl. CPC G06F 21/60; G06F 3/04847
USPC 345/173

(57) ABSTRACT

Provided is a method for controlling the displaying of interface content, said method includes: detecting a touch signal acting on a touch screen or a touchpad; judging whether a gesture corresponding to said touch signal matches with a preset gesture; and if the gesture corresponding to said touch signal matches with the preset gesture, then acquiring a mask area according to the gesture corresponding to said touch signal, and generating a mask layer on said mask area. According to the method, a mask layer can be generated on an interface to mask interface content through a simple touching operation, so as to prevent the interface content from being peeped by other people, thereby improving the security. Furthermore, a device for controlling the displaying of interface content is provided.

### RELATED APPLICATIONS

This application is a continuation application of PCT patents application No. PCT/CN2013/089061, entitled “Method and Device for Controlling the Displaying of Interface Content”, filed on Dec. 11, 2013, which claims priority to Chinese patent application No. 201310226298.3, entitled “Method and Device for Controlling the Displaying of Interface Content”, filed on Jun. 7, 2013, both of which are hereby incorporated by reference in their entirety.

### FIELD OF THE INVENTION

The present disclosure relates to the field of touch-screen device technology, and more particularly to a method and a device for controlling the displaying of interface content.

### BACKGROUND OF THE INVENTION

Along with the popularity of mobile internet, the mobile devices, such as smart mobiles, panel PC and so on, have more and more become working tools or entertainment tools in people's daily life, while the screen of a mobile device is moving towards the big screen.

The mobile device with a big screen brings convenience in use for the user; however, the bigger is the screen, it is more likely to cause the information security problem. For example, when a user sends a privacy message to another user with a smart mobile having a big screen in the subway or a public bus or other public places, said privacy message sent herein may be seen by other people inadvertently, thereby bringing security risks.

### SUMMARY OF THE INVENTION

In view of the defects of security risks existing in the prior art technology mentioned above, in one aspect, the present disclosure provides a method for controlling the displaying of interface content so as to improve the security of a mobile device in use:

A method for controlling the displaying of interface content, including following steps:

detecting a touch signal acting on a touch screen or a touchpad;

judging whether a gesture corresponding to said touch signal matches with a preset gesture; and

if the gesture corresponding to said touch signal matches with the preset gesture, then acquiring a mask area according to the gesture corresponding to said touch signal, and generating a mask layer on said mask area.

In another aspect, the present disclosure provides a device for controlling the displaying of interface content, including:

a detecting module, configured to detect a touch signal acting on a touch screen or a touchpad;

a judging module, configured to judge whether a gesture corresponding to said touch signal matches with a preset gesture; and

a mask layer generating module, configured to, if the gesture corresponding to said touch signal matches with the preset gesture, then acquire a mask area according to the gesture corresponding to said touch signal, and generate a mask layer on said mask area.

According to the method and device for controlling the displaying of interface content, when the gesture corresponding to said touch signal matches with the preset gesture, the mask area is acquired according to said gesture corresponding to said touch signal, and a mask layer is generated on said mask area to cover the information in the mask area, so that the interface content is not easy to be seen by other people, thereby improving the security of a mobile device in use.

### BRIEF DESCRIPTION OF THE DRAWINGS

FIG. 1 is a flow diagram illustrating the method for controlling the displaying of interface content according to one embodiment of the present invention;

FIG. 2 is a flow diagram illustrating the method for controlling the displaying of interface content according to another embodiment of the present invention;

FIG. 3 is a schematic diagram illustrating the operation of moving the location of the mask layer provided in the method as shown in FIG. 2;

FIG. 4 is a flow diagram illustrating the method for controlling the displaying of interface content according to another embodiment of the present invention;

FIG. 5 is a schematic diagram illustrating the operation of adjusting the size of the mask layer provided in the method as shown in FIG. 4;

FIG. 6 is a flow diagram illustrating the method for controlling the displaying of interface content according to another embodiment of the present invention;

FIG. 7 is a schematic diagram illustrating the operation of removing the mask layer provided in the method as shown in FIG. 6;

FIG. 8 is a schematic structure diagram illustrating the device for controlling the displaying of interface content according to one embodiment of the present invention;

FIG. 9 is a schematic structure diagram illustrating the device for controlling the displaying of interface content according to another embodiment of the present invention;

FIG. 10 is a schematic structure diagram illustrating the device for controlling the displaying of interface content according to another embodiment of the present invention;

FIG. 11 is a schematic structure diagram illustrating the device for controlling the displaying of interface content according to another embodiment of the present invention.

### DETAILED DESCRIPTION OF THE EMBODIMENTS

In order to make the purpose, technical solutions and advantages of the present disclosure to be understood more clearly, the present disclosure will be described in further details with the accompanying drawings and the following embodiments. It should be understood that the specific embodiments described herein are merely examples to illustrate the invention, not to limit the present disclosure.

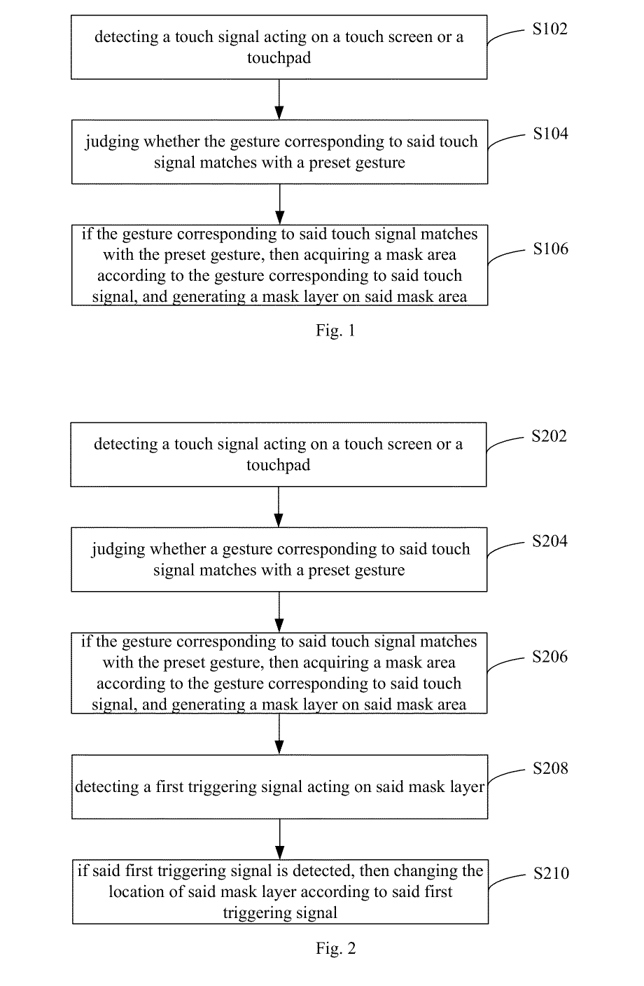

In one embodiment as shown in FIG. 1, a method for controlling the displaying of interface content is provided, which is illustrated by an example applied in a terminal with a touch screen or a touchpad, and said method includes following steps:

S102: detecting a touch signal acting on a touch screen or a touchpad.

Taking a terminal with a touch screen as an example, said touch signal may be acquired through a touching operation in said touch screen with multiple fingers by a user.

S104: judging whether the gesture corresponding to said touch signal matches with a preset gesture.

S106: if the gesture corresponding to said touch signal matches with the preset gesture, then acquiring a mask area according to the gesture corresponding to said touch signal, and generating a mask layer on said mask area.

In this embodiment, when the gesture corresponding to said touch signal matches with the preset gesture, then, the mask area is acquired according to said gesture corresponding to said touch signal, and a mask layer is generated on said mask area. Since the mask layer can cover the interface content in the mask area, when using a terminal with a touch screen or a touchpad, the user can mask the interface content which is not desired to be peeped by other people, so as to reduce security risks and increase the security.

In one embodiment, the step S104 includes:

acquiring touch points corresponding to said touch signal;

judging whether the number of said touch points is no less than 3, and whether the touch time reaches the preset threshold.

Since the operation, which can be responded to by an application program, such as an operation of clicking or sliding, and so on, normally has 1 or 2 touch points, only when the number of touch points reaches three, the corresponding touching operation can be distinguished from those operations directing to an application program running on the interface. For example, the user may use four fingers touching the touch screen at the same time, or form a surface contact with the touch screen through holding four fingers straight together, and so on. In order to avoid misoperation, it is further detected whether the touch time reaches the preset threshold, preferably, said preset threshold is three seconds.

In this embodiment, when the number of touch points reaches three and the touch time reaches the preset threshold, a mask area is acquired according to the touch points corresponding to the touch signal, specifically, a mask area containing all the touch points is acquired. Preferably, said mask area is the minimum area containing all the touch points, which may be an area having a fixed shape such as a rectangular area, a circular area, a triangle area, and so on, the present disclosure does not intend to limit the shape of the mask area. Furthermore, a mask layer is generated on the mask area to cover the interface content in the mask area.

In this embodiment, when the number of the touch points is no less than three and the touch time reaches said preset threshold, a mask area containing the touch points is acquired, and a mask layer is generated on the mask area. Since the mask layer can cover the interface content in the mask area, when using a terminal with a touch screen or a touchpad, the user can mask the interface content which is not desired to be peeped by other people, so as to reduce security risks and improve the security. Furthermore, since the mask layer is generated only when the number of touch points reaches three and the touch time reaches the preset threshold, the corresponding touching operation can be distinguished from those operations directing to an application program running on the interface, thereby avoiding misoperation.

In one embodiment, after the step S102, said method for controlling the displaying of interface content further includes: detecting whether the number of touch points is no less than four and whether the touch time reaches the preset threshold; if the number of touch points is no less than four and the touch time reaches the preset threshold, then acquiring a mask area containing the touch points, and generating a mask layer on the mask area.

In this embodiment, the mask layer is generated when the number of touch points reaches four and the touch time reaches the preset threshold, therefore, the corresponding touching operation can be distinguished from those operations directing to an application program running on the interface, which further helps to avoid misoperation.

In another embodiment, said step S104 further includes: judging whether the touch track corresponding to said touch signal matches with a preset track.

Said preset track may be a pre-set specific track, such as a circular track, a rectangular track, a triangle track or a track imitating a certain character (such as a track in the shape of “X”), and so on. The term “match with” in the embodiments of the present invention does not mean that the touch track corresponding to the touch signal is identical with the preset track, but means that the similarity between the touch track corresponding to the touch signal and the preset track is within a certain value range.

In this embodiment, when the touch track corresponding to the touch signal matches with the preset track, a mask area is further acquired according to the touch track corresponding to the touch signal, specifically, the area encompassed by the touch track may be acquired as the mask area, for example, the touch track is a circle track, then the area encompassed by said circle track is acquired as the mask area; or the area containing the touch points of the touch track may be acquired as the mask area, for example, the touch track is a track in the shape of “X”, the area containing all touch points of said track is acquired as the mask area. Furthermore, a mask layer is generated on the mask area.

In this embodiment, when the touch track corresponding to the touch signal matches with the preset track, the mask layer can also be generated directly, thereby the mask layer is generated through a certain track. Since the mask layer can cover interface content in the mask area, when using the terminal with a touch screen or a touchpad, the user can mask the interface content which is not desired to be peeped by other people, so as to reduce the security risks and improve the security. Furthermore, the touch track can be distinguished from those operations directing to an application program running on the interface, thereby avoiding misoperation.

In one embodiment as shown in FIG. 2, on the basis of the embodiment as shown in FIG. 1, the method for controlling the displaying of interface content further includes steps of S208 and S210. Specifically, said method herein includes:

S202: detecting a touch signal acting on a touch screen or a touchpad;

S204: judging whether a gesture corresponding to said touch signal matches with a preset gesture;

S206: if the gesture corresponding to said touch signal matches with the preset gesture, then acquiring a mask area according to the gesture corresponding to said touch signal, and generating a mask layer on said mask area;

S208: detecting a first triggering signal acting on said mask layer;

S210: if said first triggering signal is detected, then changing the location of said mask layer according to said first triggering signal.

In this embodiment, said first triggering signal may be a signal generated by operations of clicking on and sliding the mask layer. Preferably, said first triggering signal is a signal generated by operations of clicking within a central region of the mask layer and sliding the mask layer.

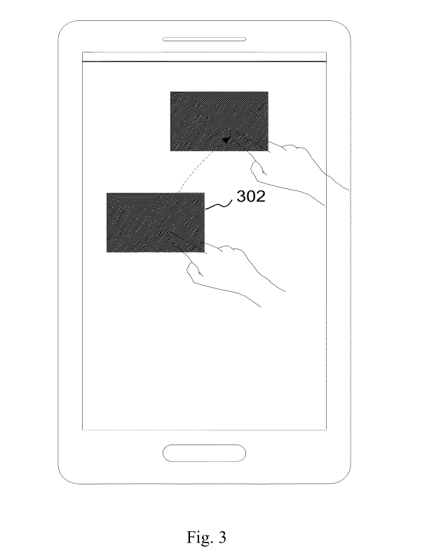

As shown in the schematic diagram of FIG. 3 illustrating the operation of moving the location of the mask layer, the user may touch the area where the mask layer 302 is located with fingers, when the touching operation on the mask layer 302 is detected, said mask layer 302 enters a movable state, if the user operates the mask layer 302 to slide in the touch screen, then said mask layer 302 moves along the sliding track.

In this embodiment, the mask layer 302 can be moved to any area to be masked; since only the first triggering signal acting on the mask layer is detected, the sliding operation can be distinguished from those operations directing to an application program running on the interface, thereby causing no misoperation, and improving the convenience of use.

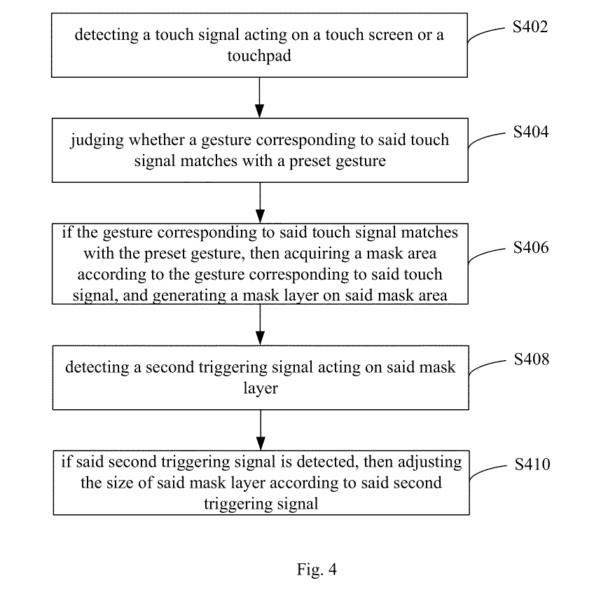

In another embodiment as shown in FIG. 4, on the basis of the embodiment as shown in FIG. 1, the method for controlling the displaying of interface content further includes steps of S408 and S410. Specifically, said method herein includes:

S402: detecting a touch signal acting on a touch screen or a touchpad.

S404: judging whether a gesture corresponding to said touch signal matches with a preset gesture.

S406: if the gesture corresponding to said touch signal matches with the preset gesture, then acquiring a mask area according to the gesture corresponding to said touch signal, and generating a mask layer on said mask area.

S408: detecting a second triggering signal acting on said mask layer;

S410: if said second triggering signal is detected, then adjusting the size of said mask layer according to said second triggering signal.

In this embodiment, said second triggering signal may be a signal generated by clicking on an edge of the mask layer and sliding the mask layer.

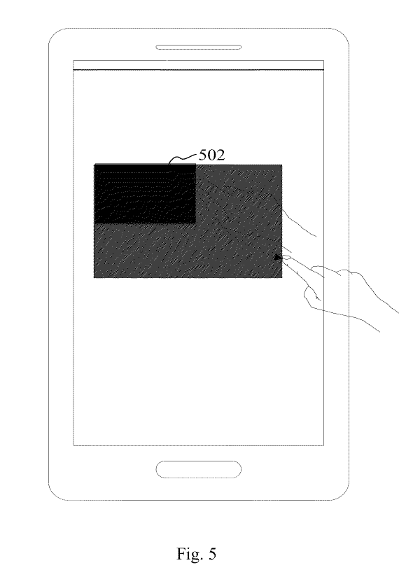

As shown in the schematic diagram of FIG. 5 illustrating the operation of adjusting the size of the mask layer, the user touches an edge of the mask layer 502 with fingers, when a touching operation on the edge of the mask layer 502 is detected, the mask layer 502 enters a size editable state, furthermore, when the sliding operation on the edge of the mask layer 502 is detected, the mask layer 502 changes its size along the sliding track.

In one embodiment, the mask layer generated herein can imitate some special paper texture, for example, the mask layer is displayed as curling craft paper, and so on. In this embodiment, the second triggering signal may be a signal generated by operations of clicking on the curling edge of the craft paper and sliding the craft paper; when said second triggering signal is detected, the user can adjusts the size of the mask layer through dragging the curling edge of the mask layer.

In this embodiment, the size of the mask layer can be adjusted so that the mask layer can mask any size of interface content in the interface, thereby improving the convenience of use.

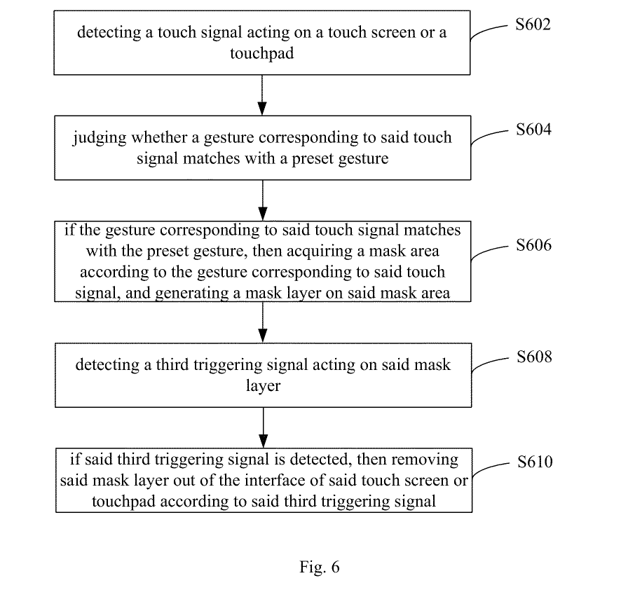

In another embodiment as shown in FIG. 6, on the basis of the embodiment as shown in FIG. 1, the method for controlling the displaying of interface content further includes steps of S608 and S610. Specifically, said method herein includes:

S60: detecting a touch signal acting on a touch screen or a touchpad.

S604: judging whether a gesture corresponding to said touch signal matches with a preset gesture.

S606: if the gesture corresponding to said touch signal matches with the preset gesture, then acquiring a mask area according to the gesture corresponding to said touch signal, and generating a mask layer on said mask area.

S608: detecting a third triggering signal acting on said mask layer;

S610: if said third triggering signal is detected, then removing said mask layer out of the interface of said touch screen or touchpad according to said third triggering signal.

In this embodiment, said third triggering signal may be a signal generated by operations of clicking on the mask layer and sliding the mask layer to the edge of the display screen.

As shown in the schematic diagram of FIG. 7 illustrating the operation of removing the mask layer, the user may touch the area where the mask layer 702 is located with fingers; when the touching operation on the mask layer 702 is detected, the mask layer 702 enters a movable state; when it is detected that the touching points on the mask layer 702 have slid to the edge of the touch screen, the mask layer 702 is removed out of the touch screen. In this embodiment, when the mask layer 702 is not necessary, the mask layer 702 can be rapidly removed through simple operations, which is simple to operate, and convenient to use.

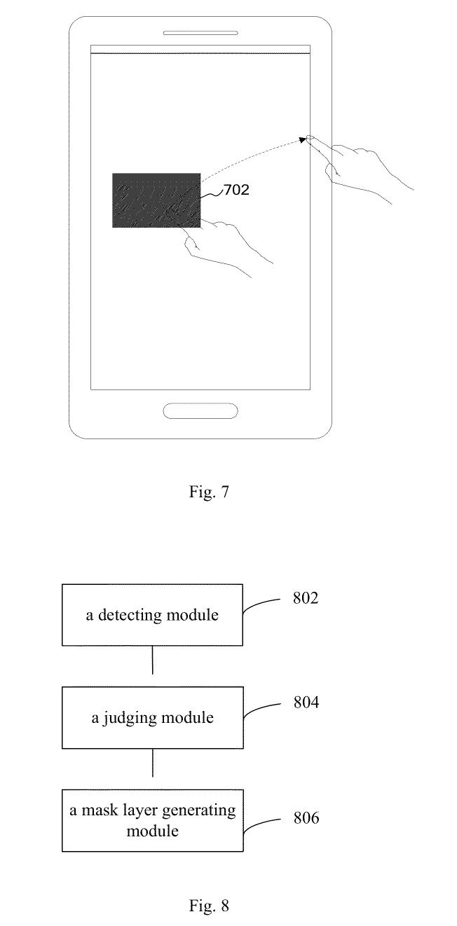

In one embodiment as shown in FIG. 8, a device is provided for controlling the displaying of interface content, said device includes:

a detecting module 802, configured to detect a touch signal acting on a touch screen or a touchpad;

a judging module 804, configured to judge whether the gesture corresponding to said touch signal matches with a preset gesture; and

a mask layer generating module 806, configured to, if the gesture corresponding to said touch signal matches with the preset gesture, then acquire a mask area according to the gesture corresponding to said touch signal, and generate a mask layer on said mask area.

In one embodiment, said judging module 804 is configured to acquire the touch points corresponding to the touch signal, judge whether the number of the touch points is no less than three and whether the touch time reaches the preset threshold. In this embodiment, said mask layer generating module 806 is also configured to, if the number of the touch points corresponding to the touch signal is no less than three and the touch time reaches preset threshold, acquire the mask area containing the touch points, and generate a mask layer on the mask area.

In one embodiment, said judging module 804 is also configured to detect whether the number of touch points is no less than four and whether the touch time reaches the preset threshold; said mask layer generating module 806 is also configured to, if the number of touch points is no less than four and the touch time reaches the preset threshold, acquire a mask area containing the touch points, and generate a mask layer on the mask area.

In another embodiment, said judging module 804 is configured to judge whether the touch track corresponding to said touch signal matches with a preset track. In this embodiment, said mask layer generating module 806 is also configured to, when the touch track corresponding to the touch signal matches with the preset track, acquire a mask area according to the touch track (specifically, the area encompassed by the touch track may be acquired as a mask area, or the area containing the touch points of the touch track may be acquired as a mask area), and then generate a mask layer on the mask area.

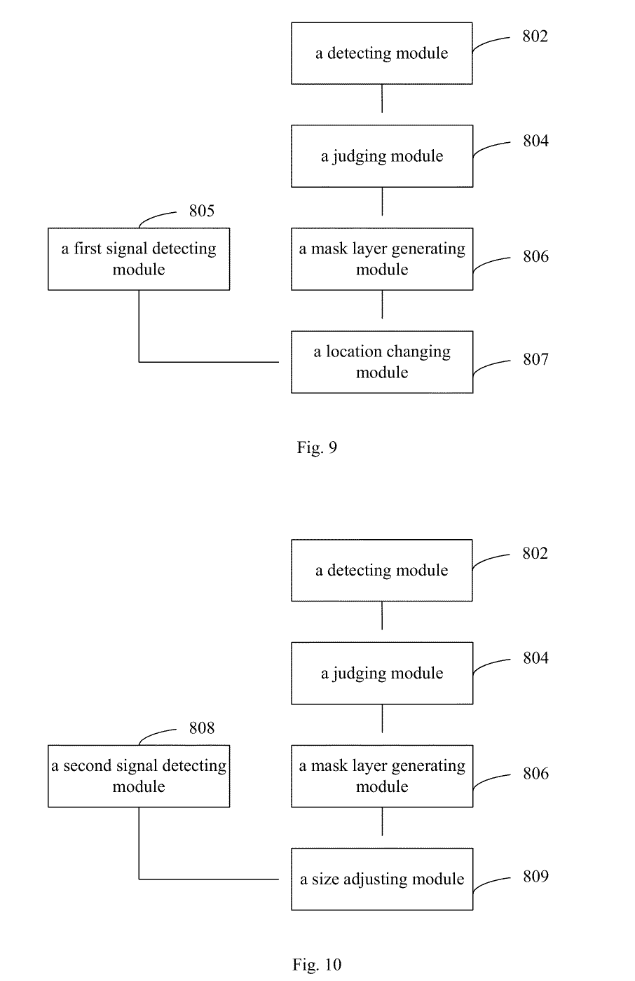

In one embodiment as shown in FIG. 9, on the basis of the embodiment as shown in FIG. 8, the device for controlling the displaying of interface content further includes:

a first signal detecting module 805, configured to detect a first triggering signal acting on said mask layer; and

a location changing module 807, configured to, if said first signal detecting module 805 detects said first triggering signal, then change the location of said mask layer according to said first triggering signal.

In another embodiment as shown in FIG. 10, on the basis of the embodiment as shown in FIG. 8, the device for controlling the displaying of interface content further includes:

a second signal detecting module 808, configured to detect a second triggering signal acting on said mask layer; and

a size adjusting module 809, configured to, if said second signal detecting module 808 detects said second triggering signal, then adjust the size of said mask layer according to said second triggering signal.

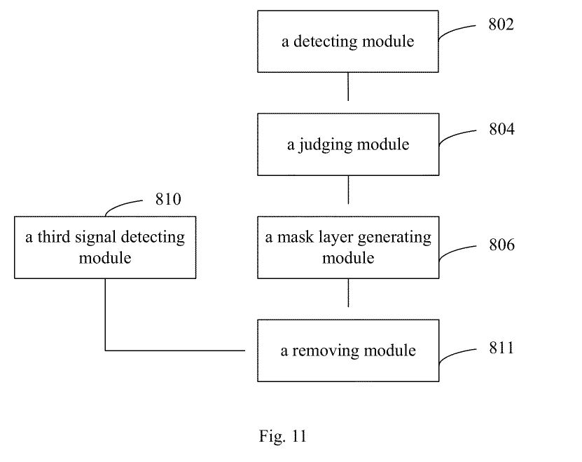

In another embodiment as shown in FIG. 11, on the basis of the embodiment as shown in FIG. 8, the device for controlling the displaying of interface content further includes:

a third signal detecting module 810, configured to detect a third triggering signal acting on said mask layer;

a removing module 811, configured to, if said third signal detecting module 810 detects said third triggering signal, then remove said mask layer out of the interface of said touch screen or touchpad according to said third triggering signal.

It should be noted that, in other embodiments, said device for controlling the displaying of interface content may simultaneously include every modules comprised in the embodiments as shown in FIG. 9, FIG. 10 and FIG. 11.

Said method and device for controlling the displaying of interface content provided in the embodiments mentioned above, may apply in a terminal with a touch screen or a touchpad, said terminal includes but not limited to a smart mobile, tablet PC, MP3 player, desktop PC, laptop PC, and so on.

The ordinary technician in the field can understand that, all of or part of the processes implementing the methods in the embodiments mentioned above, may be achieved by means of relevant hardware commanded by computer programs, the computer programs may be stored in the computer readable storage medium, and it may include the processes of embodiments of the respective methods mentioned above when the program is executed. Wherein, the storage medium may be a disk or CD or read-only memory or random access memory, etc.

The foregoing examples are preferred embodiments of the present invention only and not intended to limit the present disclosure. It should be understood that, to the person skilled in the art, various modifications and improvements can be made without departing from the spirit and principle of the present disclosure, which should all be included within the scope of the present disclosure. Therefore, the protection scope of the present disclosure shall be defined by the appended claims.

What is claimed is:

1. A method for controlling displaying of interface content, comprising following steps:
detecting a touch signal acting on a touch screen or a touchpad;
acquiring touch points corresponding to said touch signal;
judging whether a number of said touch points is no less than three, and whether touching time reaches a preset threshold; if the number of touch points corresponding to said touch signal matches with a preset number, then acquiring a mask area according to the touch points corresponding to said touch signal, and generating a mask layer on said mask area.

2. The method for controlling displaying of interface content according to claim 1, wherein, said method further comprises :
judging whether a touch track corresponding to said touch signal matches with a preset track.

3. The method for controlling displaying of interface content according to claim 1, further comprising:
detecting a first triggering signal acting on said mask layer; and
if said first triggering signal is detected, then changing the location of said mask layer according to said first triggering signal.

4. The method for controlling displaying of interface content according to claim 1, further comprising:
detecting a second triggering signal acting on said mask layer; and
if said second triggering signal is detected, then adjusting the size of said mask layer according to said second triggering signal.

5. The method for controlling displaying of interface content according to claim 1, further comprising:
detecting a third triggering signal acting on said mask layer; and
if said third triggering signal is detected, then removing said mask layer out of the interface of said touch screen or touchpad according to said third triggering signal.

6. The method for controlling displaying of interface content according to claim 1, wherein, said method for controlling the displaying of interface content is implemented in a terminal with a touch screen or a touchpad.

7. The method for controlling displaying of interface content according to claim 6, wherein, said terminal is a smart mobile, a tablet PC, a MP3 player, a desktop PC or a laptop PC.

8. A device for controlling displaying of interface content, comprising:
a detecting module, configured to detect a touch signal acting on a touch screen or a touchpad; and acquire touch points corresponding to said touch signal;
a judging module, configured to judge whether a number of said touch points is no less than three, and whether touching time reaches a preset threshold; and judge whether the number of touch points corresponding to said touch signal matches with a preset number; and
a mask layer generating module, configured to, if the gesture corresponding to said touch signal matches with the preset gesture, then acquire a mask area according to the touch points corresponding to said touch signal, and generate a mask layer on said mask area.

9. The device for controlling displaying of interface content according to claim 8, wherein, said judging module is also configured to judge whether a touch track corresponding to said touch signal matches with a preset track.

10. The device for controlling displaying of interface content according to claim 8, further comprising:
a first signal detecting module, configured to detect a first triggering signal acting on said mask layer; and
a location changing module, configured to, if said first triggering signal is detected, change the location of said mask layer according to said first triggering signal.

11. The device for controlling displaying of interface content according to claim 8, further comprising:
a second signal detecting module, configured to detect a second triggering signal acting on said mask layer; and
a size adjusting module, configured to, if said second triggering signal is detected, adjust the size of said mask layer according to said second triggering signal.

12. The device for controlling displaying of interface content according to claim 8, further comprising:
a third signal detecting module, configured to detect a third triggering signal acting on said mask layer; and
a removing module, configured to, if said third triggering signal is detected, then remove said mask layer out of the interface of said touch screen or touchpad according to said third triggering signal.

13. The device for controlling displaying of interface content according to claim 8, wherein, said device for controlling the displaying of interface content is based on a terminal with a touch screen or a touchpad.

14. The device for controlling displaying of interface content according to claim 13, wherein, said terminal is a smart mobile, a tablet PC, a MP3 player, a desktop PC or a laptop PC.

15. The method for controlling displaying of interface content according to claim 3, wherein, said method for controlling the displaying of interface content is implemented in a terminal with a touch screen or a touchpad.

16. The method for controlling displaying of interface content according to claim 4, wherein, said method for controlling the displaying of interface content is implemented in a terminal with a touch screen or a touchpad.

17. The method for controlling displaying of interface content according to claim 5, wherein, said method for controlling the displaying of interface content is implemented in a terminal with a touch screen or a touchpad.

18. The device for controlling displaying of interface content according to claim 10, wherein, said device for controlling the displaying of interface content is based on a terminal with a touch screen or a touchpad.

19. The device for controlling displaying of interface content according to claim 11, wherein, said device for controlling the displaying of interface content is based on a terminal with a touch screen or a touchpad.

20. The device for controlling displaying of interface content according to claim 12, wherein, said device for controlling the displaying of interface content is based on a terminal with a touch screen or a touchpad.
